(19) United States
(12) Patent Application Publication
(10) Pub. No.: US 2026/0283873 A1
(43) Pub. Date: Sep. 24, 2026

(54) HEIGHT-ADJUSTABLE WHEELCHAIR

(71) Applicant: Alu Rehab AS, KLEPP STASJON (NO)

(72) Inventor: Sigve Tjessem, BRYNE (NO)

(73) Assignee: Alu Rehab AS, KLEPP STASJON (NO)

(21) Appl. No.: 19/473,942

(22) PCT Filed: Apr. 5, 2024
(86) PCT No.: PCT/NO2024/050082

§ 371 Date: Oct. 9, 2025

(30) Foreign Application Priority Data
Apr. 28, 2023 (NO) 20230481

(51) Int. Cl. A61G 5/10

(52) U.S. Cl. CPC A61G 5/1059; A61G 5/1067

(57) ABSTRACT

A wheelchair which can be adjusted in a very short time. The wheelchair has a wheel frame and a seat configured with a seat plate. The position of the wheel frame is adjustable to make a height of a seat of the wheelchair adjustable. The wheel frame and the seat frame are connected via at least one sliding bracket having a first mounting part connected to the wheel frame and a second mounting part connected to the seat frame. The sliding bracket has a first mode, wherein the first mounting part and the second mounting part can slide relative to each other in a stepless manner in a longitudinal direction of the bracket to obtain a desired length of the sliding bracket. The sliding bracket has a second mode, wherein the first mounting part and the second mounting part are kept in their relative position.

### CROSS-REFERENCE TO RELATED APPLICATIONS

This application is the U.S. national stage application of International Application No. PCT/NO 2024/050082, filed Apr. 5, 2024, which international application was published on Oct. 31, 2024, as WO 2024/225909 in the English language. The International Application claims priority to Norwegian Patent Application No. 20230481, filed on Apr. 28, 2023. The international application and Norwegian application are both incorporated herein by reference, in their entirety.

### FIELD

The invention relates to a height-adjustable wheelchair.

### BACKGROUND

Height-adjustable wheelchairs are known. There are 2 situations where this seat height adjustment is important:
1) New wheelchairs will be adjusted to the wheelchair user. Upfront delivery measurements will be taken before delivering the wheelchair. It is not always easy to predict/measure the correct seat height. When the chair is delivered, the seat height needs to be adjusted further in some cases. Adjusting the wheelchair in height can be time consuming and is not always easy since new wheels may be needed to adjust the wheelchair to the correct height, or the front and rear wheels need to be changed to a higher or lower positioning. If the correct height cannot be found with the delivered wheels, new wheels or front fork needs to be ordered. This results in extra waiting time for a wheelchair to be used by the user and attendant, and extra work and visits from the sales representative, resulting in higher costs.
2) To be environmentally friendly, wheelchairs are re-used/refurbished. The height needs to be adjusted to a new user. In e.g., hospitals, this will be done on a more frequent basis when compared with wheelchairs used in a home environment. The total amount of wheelchairs and spare parts at the hospital can in this way be reduced, and the time it takes to adjust the wheelchair to a new user can be reduced significantly.

Different solutions have been presented in the prior art.

For example, PCT publication WO2017/0143454 discloses a mid-wheel tilt-in-space manual wheelchair with a constant shoulder position. The tilting wheelchair comprises an upper section, a lower section, and a tilting mechanism. The upper section comprises an upper frame defining a user's seat, a back post, and an armrest. The lower section comprises a lower frame, two drive wheels and at least two guiding wheels, preferably, two rear casters and two front casters. The two drive wheels being positioned on the lower frame and have a same rotation axis. The tilting mechanism is being adapted to rotatably engage the upper section to the lower section in such a way that the pivot centre of the upper section is being coincident at any moment and any position with the rotation axis of the drive wheels allowing to maintain a constant distance between a user's shoulder and each push rim of each drive wheel. The wheelchair is also height-adjustable by the rotation axle between the seat and wheel frame being able to slide inside a slot in the seat frame. Then the height is fixed by providing bolts in pre-formed holes placed on both side of the slot. The resulting chair allows for a stepwise adjustment of the height as defined by the distance between neighbouring holes.

DE2,426,629A1 discloses a folding wheelchair device having two side frames joined to the backrest and at least one axle box into which the rear drive wheels are mounted. An adjusting screw device to adjust the length of the back frame section is mounted just above the axle boxes. As a result of adjusting the length of the back frame the angle of the back rest to the travelling plane can be further altered by varying the position of the wheels in the axle boxes. The front wheel is mounted on a constantly variable bearing.

WO21072911A1 discloses a transfer means comprising a base frame, a seat frame assembly arranged above the base frame, and a spiral lifting mechanism provided between the base frame and the seat frame assembly. The spacing distance between the base frame and the seat frame assembly can be adjusted by means of the spiral lifting mechanism. The spiral lifting mechanism performs lifting actions by means of a screw thread lifting principle. The height of the seat frame assembly can be adjusted when a person is carried. Stepless adjustment can be achieved, and the height can be adjusted to any height within a height adjustment range.

DE 41 14 252 A1 discloses a wheelchair having a base frame to which wheels are attached. The wheelchair has a seat which is provided with a hinged foot-rest and which can be raised above its normal seating position. The seat frame is guided by a telescopic guide which consists of at least three parts which can move relative to each other and which are actuated by an electric motor. The seat can also be lowered below its normal seating position. The seat is held in its horizontal position when raised, by a gas spring,

EP1166741 discloses a lifting and transport apparatus for disabled person. The apparatus has a horizontal bar with pivot arms and front wheel steering. A foot support has storage space. A seat has a removable safety support. Steering wheels with brakes are fixed to vertical lifting column supported on the horizontal bar with angle plate. A lifting slide is guided vertically on the lifting column and can be fixed at adjustable heights. A horizontal rotatable seat unit has a seat support pipe and a seat support cross with a rotatable seat shell. Support devices and a support arm are mounted on the device as well as an inclined table. Additional wheels allow the patient to drive the device.

In view of the above-described problems and existing solutions there is a need to further develop compact tiltable wheelchairs.

### SUMMARY

The invention has for its object to remedy or to reduce at least one of the drawbacks of the prior art, or at least provide a useful alternative to prior art.

The object is achieved through features, which are specified in the description below and in the claims that follow.

The invention is defined by the independent patent claims. The dependent claims define advantageous embodiments of the invention.

In a first aspect the invention relates to a wheelchair comprising a wheel frame and a seat frame connected to the wheel frame. The wheel frame is connectible to a set of front wheels and a set of rear wheels. The seat frame is configured with a seat plate for allowing a user to sit on it, wherein the position of the wheel frame relative to the seat frame is adjustable in order to make a height of the seat of the wheel-chair adjustable. The wheel frame and the seat frame are connected via at least one sliding bracket, the sliding bracket comprising a first mounting part connected to the wheel frame and a second mounting part connected to the seat frame, wherein the first mounting part and the second mounting part are coupled together in operational use. In each sliding bracket one of the mounting parts is provided with at least one elongated slot on a side facing the other one of the mounting parts, wherein each elongated slot provides access to a respective internal channel for receiving a sliding bar which can move back and forth the internal channel, wherein the sliding bar is provided with at least one threaded hole for receiving a respective mounting bolt. In each sliding bracket the other one of the mounting parts is provided with at least one through-hole for receiving a respective mounting bolt, The at least one through-hole is spaced apart and is aligned with the threaded holes in the sliding bar, wherein each mounting bolt is provided through the through-hole into the respective threaded-hole such that a sliding movement of one part relative to the other part causes the respective sliding bar to slide within the respective internal channel. The sliding bracket has a first mode being a low-friction mode allowing adjustment of the height of the seat by sliding, by means of human force, the first mounting part relative to second mounting part in a stepless manner in a longitudinal direction of the bracket to obtain a desired length of the sliding bracket. The sliding bracket has a second mode being a high-friction mode resisting length adjustment between the first mounting part and the second mounting part and being capable of withstanding forces during mandatory safety, durability, and reliability tests for wheelchairs. The first mode is obtained when the bolts are partially loosened, and the second mode is obtained when the bolts are tightened.

The effects of the features of the wheelchair in accordance with the invention are as follows. First of all, the invention provides a wheelchair with a sliding bracket configured for a stepless height adjustment in the first mode while keeping its length and position in the second mode. At least one sliding bracket connects the wheel frame with the seat frame. So, in order to adjust the height of the wheelchair to the user, all what is required is to put all brackets in their first mode, adjusting their lengths, and then putting all brackets in their second mode. This can be done very quickly, that is a few minutes when the wheelchair is put on its back and does not require the adjustment nor ordering/replacement of the wheels.

To facilitate understanding of the invention one or more expressions are further defined hereinafter.

Wherever the wording “height of the seat” is used, this must be interpreted as the distance between the upper surface of the seat and the floor/ground on which the wheelchair stands.

Wherever the wording “sliding bracket” is used, this must be interpreted as a mechanical connection which allows for mounting to the seat frame and wheel frame via mounting portions while simultaneously being capable of adjusting and setting the relative distance between the seat frame and wheel frame by being adjustable in at least one dimension. The adjustability in at least one dimension is defined by a distance-adjustability of the respective mounting portions of the sliding bracket, wherein the distance is controlled by a first mounting part of the bracket being movable relative to a second mounting part. The parts may be sliding (slidable) in or along each other or a combination of these two effects.

Wherever the word “hinge” is used, this must be interpreted as equivalent to “pivot point” or “rotation axle” or any other means to pivotable connect two or more mechanical parts.

Wherever the word “rod” is used, this must be interpreted as equivalent to “bar”, “arm”, “tubular structure”, or any other mechanical elongate structure that may form part of a frame.

The low-friction mode is advantageous because it facilitates the adjustment of the height using human force.

As stated above, each sliding bracket is configured such that the second mode is a high-friction mode resisting length adjustment and being capable of withstanding forces during mandatory safety tests, durability tests and reliability-tests for wheelchairs. Such tests are typically laid out in ISO-standards such as EN 12183:2014. The high-friction mode is advantageous, because it is to be designed such that the height remains the same when a person sits on the chair, but also remains the same during a car crash or daily use over a long period.

An advantageous of the present invention is that the wheelchair provides a length-adjustable construction of the sliding bracket providing both the low-friction mode and the high-friction mode. In a further variant each sliding bracket preferably comprises at least two parallel arrangements of said elongated slots and corresponding internal channels placed parallel to each other. This embodiment is further explained with refence to the drawings and provides more stability and robustness particularly in the second mode.

In an embodiment of the wheelchair in accordance with the invention each sliding bracket is configured with a contact interface between first mounting part and second mounting part having a topology for i) facilitating relative movement between the mounting parts, when in contact, in the longitudinal direction in the first mode while blocking relative movement between the mounting parts, when in contact, in a sideways direction orthogonal to the longitudinal direction, and for ii) defining the required friction in the second mode. This embodiment is further explained with refence to the drawings. The topology may be matching and improves the stability and stiffness of the sliding brackets.

In an embodiment of the wheelchair in accordance with the invention the contact interface is shaped such that, when the first mounting part and the second mounting part are pressed together in the second mode, only portions of associated surfaces can touch each other while other portions of the associated surfaces are designed to keep a gap there between. This embodiment is further explained with refence to the drawings. The friction in the first and second mode in this embodiment are determined by the size of the portion of the associated surface (contact surface) relative to the total size of the associated surfaces.

In accordance with the invention, each sliding bracket is configured such that the second mode is a locking mode which blocks relative movement between the first mounting part and the second mounting part. The invention is in its core about a stepless adjustment of the sliding bracket. There are many mechanical solutions to this, which as such are well-known to the person skilled in the art. In all these variants it boils down to adding a further part which locks the relative position between the first mounting part and the second mounting part.

In an embodiment of the wheelchair in accordance with the invention the wheelchair has two respective sliding brackets arranged on opposite sides near the arm rests of the wheelchair. This embodiment is further explained with reference to the drawings.

In an embodiment of the wheelchair in accordance with the invention the wheelchair has four respective sliding brackets of which two arranged spaced apart at the front side and two arranged spaced apart at the rear side. This embodiment forms an alternative to the two-bracket solution as illustrated in the drawings. As an alternative to the four-bracket solution of this embodiment, one could also implement a three-bracket solution having two brackets at the front side and one bracket at the rear side, or two brackets at the rear side and one bracket at the front side, for example.

### BRIEF INTRODUCTION OF THE DRAWINGS

In the following is described example of a preferred embodiment illustrated in the accompanying drawings, wherein:

FIG. 1 shows a perspective view of an embodiment of the wheelchair in accordance with the invention;

FIG. 2 shows an enlarged view of part of the wheelchair of FIG. 1;

FIGS. 3a-3c show side views of the wheelchair of FIG. 1, at seat heights, wherein the wheelchair as the same wheels in all positions;

FIG. 4 shows an assembly comprising part of the seat frame, part of the wheel frame and the sliding brackets connecting these parts;

FIG. 5 shows a top view of the assembly of FIG. 4, wherein the sliding brackets are partially shown as a cross-sectional view;

FIG. 6 shows an enlarged view of part of FIG. 4, wherein further aspects of the sliding bracket are illustrated;

FIG. 7 shows another enlarged view of part of FIG. 4, wherein other aspects of the sliding bracket are illustrated;

FIG. 8 shows a cross-sectional view and some further aspects of part of the sliding bracket in FIGS. 4-8, and

FIGS. 9a-9b shows a further embodiment of the wheelchair of the invention using a different tightening mechanism.

### DETAILED DESCRIPTION OF THE EMBODIMENTS

Various illustrative embodiments of the present subject matter are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The present subject matter will now be described with reference to the attached figures. Various systems, structures and devices are schematically depicted in the drawings for purposes of explanation only and to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

### The Invention Will Be Discussed With Reference to the Figures Hereinafter.

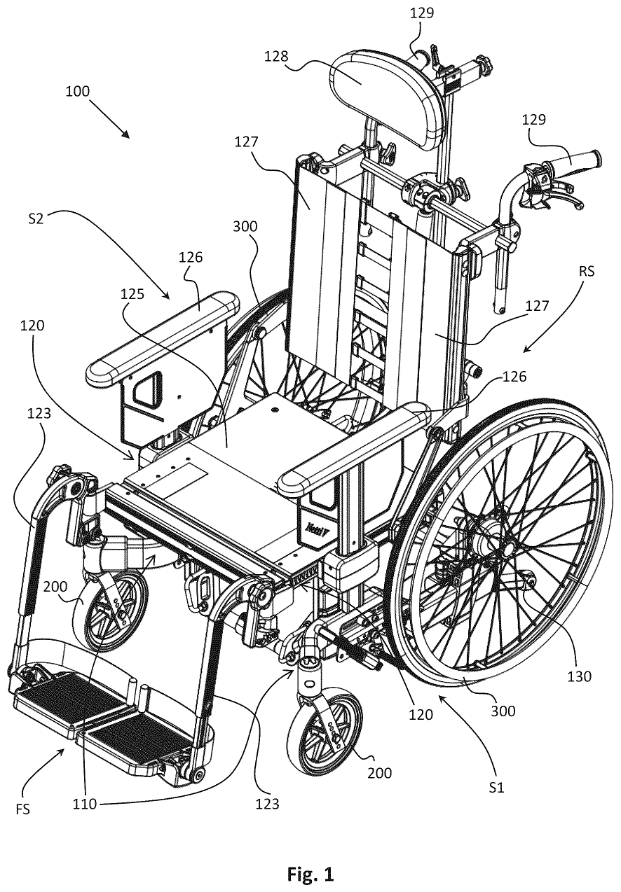

FIG. 1 shows a perspective view of an embodiment of the wheelchair 100 in accordance with the invention. The wheelchair 100 comprises a wheel frame 110 connected to a seat frame 120. Although the wheel frame 110 may comprise many mechanical parts, a main function of the wheel frame 110 is to support the seat frame 120 and allow connecting with wheels 200, 300. In the current embodiment the wheelchair 100 has two small front wheels 200 and two large rear wheels 300 as illustrated. FIG. 1 also illustrates an anti-tip-over device 130 connected to the wheel frame 110 at the rear side RS of the wheelchair 100. There are various components connected to the seat frame 120. At a front side FS of the wheelchair 100 there are mounted two footrests 123. In alternative embodiments the two footrests 123 may be combined into one footrest for supporting both feet of a user. Using individual footrests 123 has the advantage that each footrest may be individually adapted to the length of the respective leg of the user. Leg length difference is often observed with people. A main function of the seat frame 120 is to support and connect to the seat plate 125, but also the arm rests 126 and the backrest 127 as illustrated. The arm rests 126 are adjustable in height and depth. At the rear side RS the seat frame is also provided with a fully-adjustable headrest 128 and handles with controls 129 for those who are pushing the wheelchair 100.

The figure does not clearly illustrate how the wheel frame 110 is connected with the seat frame 120, but this will be further explained and shown with reference to other figures. What is important to mention is that a height of the seat must be adapted to the user in view of the person total length, total leg length and ratio between lower leg and upper leg length. Where height-adjustability of the wheelchair 100 has already been shown in the prior art, most solutions require adaption of the wheels after that seat height has been set. The invention on the contrary does not require such adaption and it provides for a much faster adjustment, i.e., it requires only a few minutes to adjust. In order to facilitate reading of the drawings, components such as cushions are left out.

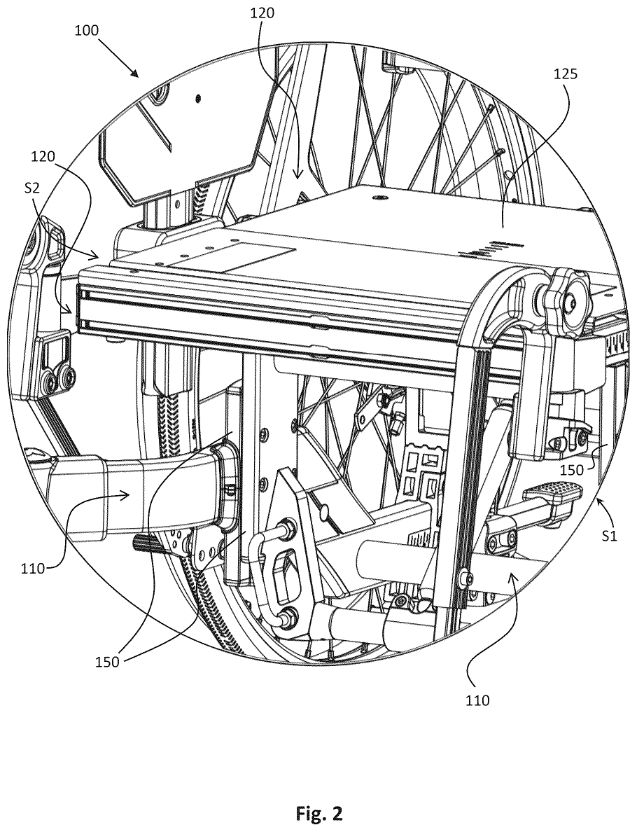

FIG. 2 shows an enlarged view of part of the wheelchair 100 of FIG. 1. The figure will only be discussed in as far as it shows further aspects and details. In this figure two sliding brackets 150 are shown, one on the right side S2 of the wheelchair 100 and one on the left side S1 of the wheelchair 100. Each slide bracket 150 connects the wheel frame 110 to the seat frame 120 while allowing the relative position between the wheel frame 110 and the seat frame 120 to be adjusted by adjustment of the sliding bracket 150.

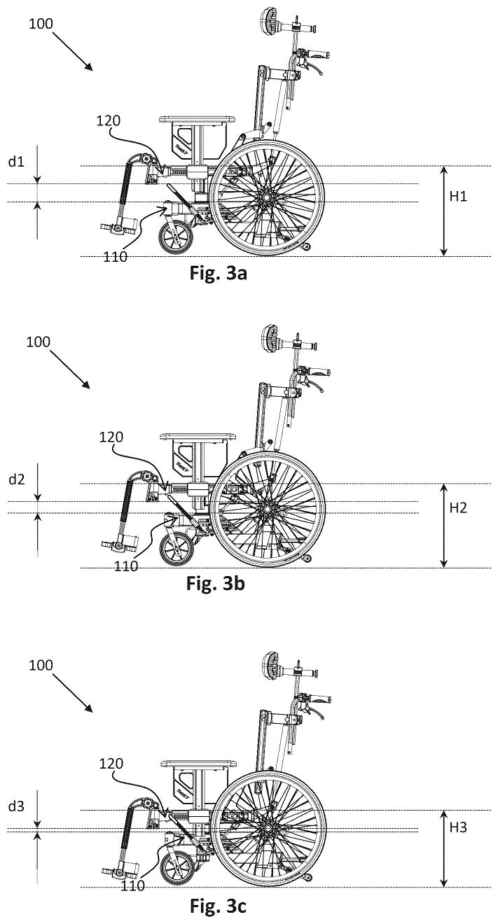

FIGS. 3a-3c show side views of the wheelchair 100 of FIG. 1, at different seat heights, wherein the wheelchair as the same wheels in all positionsNo. FIG. 3a shows a first distance d1 between the wheel frame 110 and the seat frame 120. How and where this first distance d1 is measured, is a matter of choice. However, the same reference points are used for this measurement in FIGS. 3b and 3c. In FIG. 3a the distance d1 is the largest and therefore the height H1 of the seat (not shown) is the highest. In FIG. 3b the distance d2 is a bit smaller and therefore the height H2 of the seat is a bit lower, as illustrated. In FIG. 3c the distance d3 is the smallest and therefore the height H3 of the seat is the smallest. It is important to note that the seat height differences are only determined by the bracket.

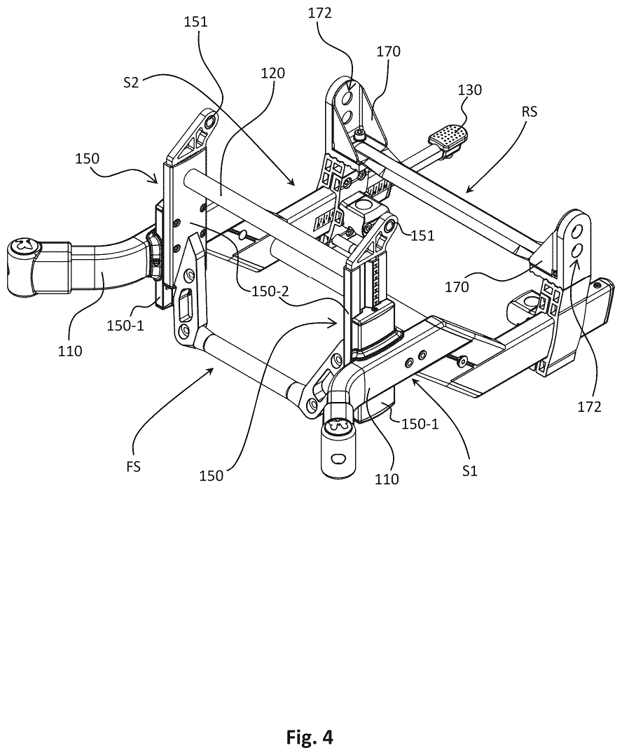

FIG. 4 shows an assembly comprising part of the seat frame 120, part of the wheel frame 110 and the sliding brackets 150 connecting these parts. The figure also shows the earlier definitions of front side FS, rear side RS, left side S1 and right side S2 of the wheelchair 100. The figure shows how the two brackets 150 on the front side FS each comprise two parts 150-1, 150-2 that are sliding relative to each other. The respective parts 150-2 on an inner side of the brackets 150 are connected together via the seat frame 120 having connecting rods as illustrated. The respective parts 150-1 on an outer side of the brackets 150 are connected to the wheel frame 110. At a topside of the brackets 150 there are visible hinge points 151 which are connectible to further parts of the seat frame 120 and allow for pivoting movement of the seat (not shown) relative to the wheel frame 110. On the rear side RS of the assembly there are mounted rear wheel brackets 170 connected together via a further rod. These rear wheel brackets 170 each comprise a plurality of fixation holes 172 wherein rear wheels (not shown) may be mounted. The plurality of fixation holes 172 enable different heights of the wheelchair 100 besides the height-adjustment of the brackets 150. The earlier discussed anti-tip-over device 130 is also shown in FIG. 4.

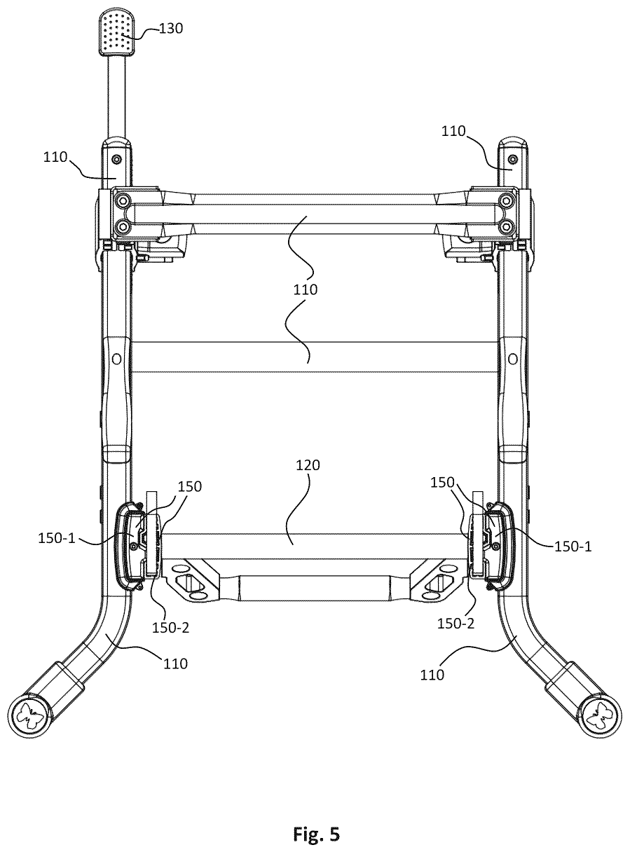

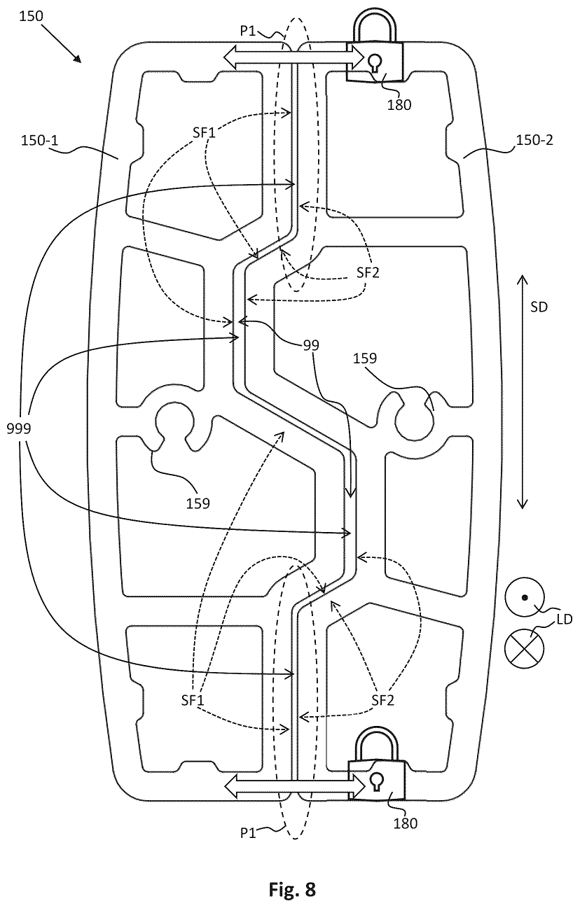

FIG. 5 shows a top view of the assembly of FIG. 4, wherein the sliding brackets 150 are partially shown as a cross-sectional view. The figure also more clearly shows what parts belong to the wheel frame 110 and what parts to the seat frame 120. The sliding brackets 150 each comprise a first mounting part 150-1 which cooperates with a second mounting part 150-2 as illustrated. The brackets 150 are designed such that they have a first mode wherein the first mounting part 150-1 can slide relative to the second mounting part 150-2 in a direction perpendicular to the plane of the figure, and a second mode wherein relative movement between these parts 150-1, 150-2 is blocked. FIG. 5 also illustrates that the respective parts 150-1, 150-2 of the brackets 150 are designed with matching topologies, which will be further explained with reference to FIG. 8.

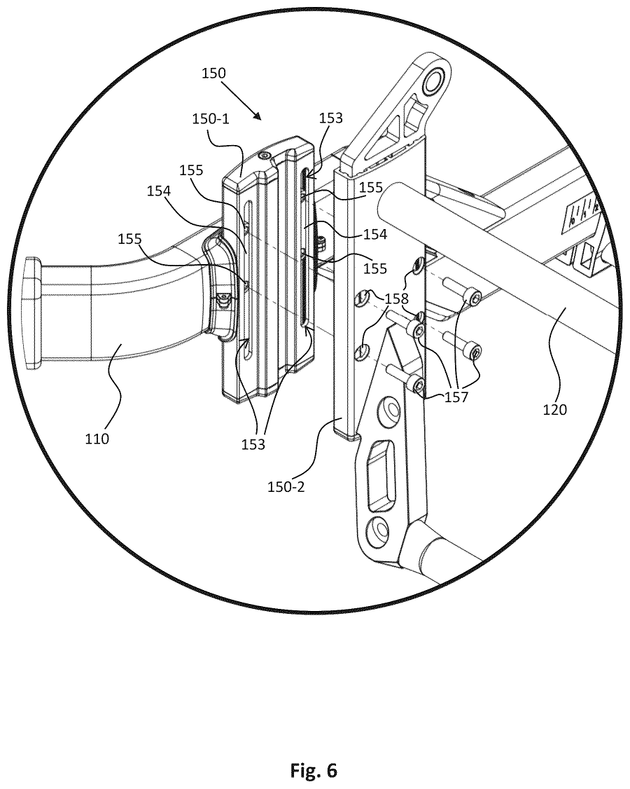

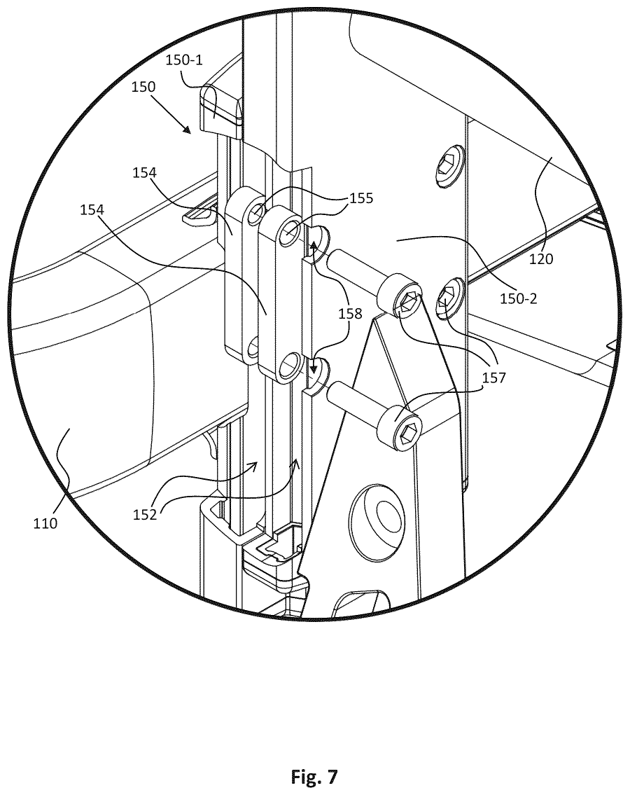

FIG. 6 shows an enlarged view of part of FIG. 4, wherein further aspects of the sliding bracket 150 are illustrated. This figure serves to illustrate how the brackets 150 are designed with the earlier-mentioned two modes. In the first mode the first mounting part 150-1 and the second mounting part 150-2 can slide relative to each other in a stepless manner in a longitudinal direction of the bracket 150 to obtain a desired length of the sliding bracket 150. In the second mode the first mounting part 150-1 and the second mounting part 150-2 are kept in their relative position. The first mounting part 150-1 that is connected with the wheel frame 110 is provided with a topology on its side facing the second mounting part 150-2. The topology includes two parallel elongated slots 153 which give access to internal channels 152 (not shown in FIG. 6, but visible in FIG. 7). Inside each of these internal channels 152 there is provided a sliding bar 154, having two respective threaded holes 155 for receiving bolts 157, as illustrated. The bolts 157 are provided through through-holes 158 in the second mounting part 150-2 and to be mounted into the threaded holes 155 of the sliding bar 154 as illustrated. An important remark to be made is that while the sliding brackets 150 form the connections between the wheel frame 110 and the seat frame 120 at a front side of the wheelchair 100, the connection at the rear side is, in this embodiment, established by a gas spring (not visible) which also provides for a tilting function.

FIG. 7 shows another enlarged view of part of FIG. 4, wherein other aspects of the sliding bracket 150 are illustrated. This figure serves to illustrate that also the second mounting part 150-2 has an internal channel 152 having a sliding bar 154 similar to the sliding bar in the first mounting part 150-1. However, this sliding bar 154 is not designed for sliding, but rather for reducing the fringe forces/deforming forces on the bolts 157, when these have been inserted through the through-holes 158 into the threaded holes 155 in the sliding bar 154.

With reference to FIGS. 6 and 7 it is mentioned that the first mode is obtained when the bolts 157 are partially loosened, which allow the sliding bar 154 in the first mounting part 150-1 to move up and down the internal channel 152. The sliding bar 154 in the second mounting part 150-1 is kept in place by the bolts 157. The second mode is obtained when the bolts 157 are tightened, which increases the friction between the first mounting part 150-1 and the second mounting part 150-2 to a level where the bracket 150 keeps its dimensions, even when a user sits on the wheelchair 100. The friction level between the first mounting part 150-1 and the second mounting part 150-2 is an important design parameter and is preferably determined by a special design as will be discussed in view of FIG. 8. Not only it must tolerate normal usage when the user sits on the chair, also it must be able to tolerate much higher forces which may occur during usage. The wheelchair 100 of the invention has been exposed to several safety tests, durability tests and reliability tests on which it will be elaborated on later. The wheelchair 100 successfully passed these tests.

With reference to FIGS. 6 and 7 it is further mentioned that one of the first mounting part 150-1 and the second mounting part 150-2 may be provided with a (printed) scale on it to facilitate setting the required height of the wheelchair 100.

FIG. 8 shows a cross-sectional view and some further aspects of part of the sliding bracket 150 in FIGS. 4-8. This figure serves to illustrate the topology of the first mounting part 150-1 and the second mounting part 150-2 of the bracket 150. It shows a contact interface 999 between the parts which is not flat but forms matching topologies on both parts 150-1, 150-2. This topology facilitates movement in a longitudinal direction (LD) in the first mode while it blocks movement in a sideways direction (SD) orthogonal to the longitudinal direction (LD) as illustrated. The topology of the parts 150-1, 150-2 is designed such that only portions P1 of associated surfaces SF1, SF2 of said parts 150-1, 150-2 contact each other, while at other portions there is a gap 99. The ratio between a size of the portions P1 and the size of the surfaces SF1, SF2 is a design parameter which determines the friction between the parts 150-1, 150-2.

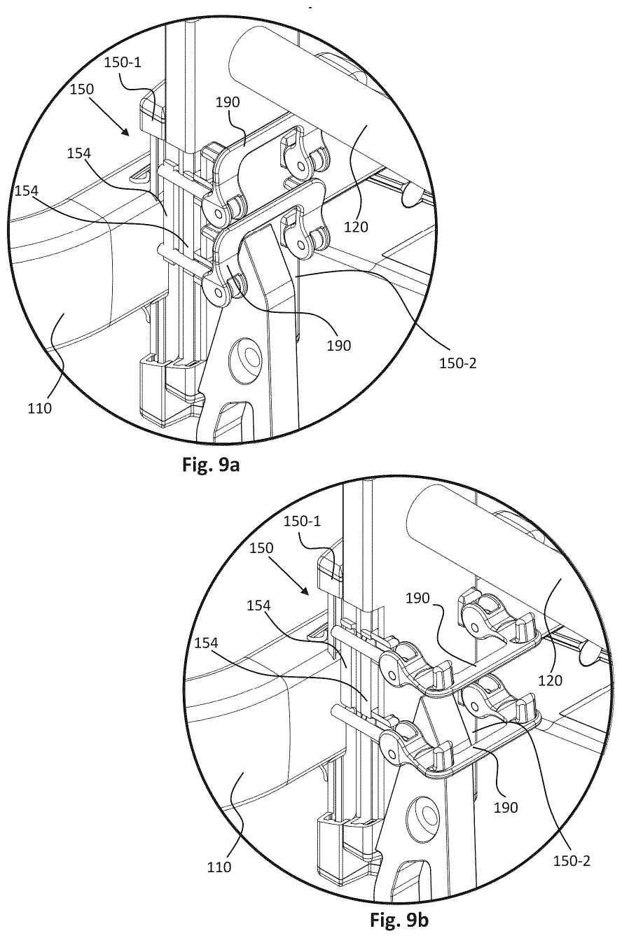

FIGS. 9a and 9b show a further embodiment of the wheelchair 100 of the invention using a different tightening mechanism. The figure will be discussed in as far as it differs from FIG. 7. Instead of using four bolts 157 per bracket 150 this embodiment has implemented two quickly-release devices 190 for tightening the mounting parts 150-1, 150-2 brackets 150 together in the second mode. Each quick-release device 190 replaces two bolts and cooperates with the earlier-discussed sliding bars 154, the threaded-holes 155, and the through-holes 158. In FIG. 9a the quick-release devices 190 are locked, wherein the handles are pushed towards the bracket 150. In FIG. 9b the quick-release devices 190 are released, that is the handles are rotated outward, effectively reducing the tension on the bolts replacements.

The main challenge when designing a wheelchair 100 is to find a balance between:
1) easy adjustability;
2) avoid loss of position at various situations during daily use of the wheelchair and in an unfortunate car crash, and
3) pass all tests needed to be sold as a ISO-certified wheelchair.

The wheelchair needs to pass the following tests:
1) a crash test in order to be allowed as seat in a car.
2) two drum tests and drop tests which is a simulation of 5-year consumer use.
3) a push-bow test, where the chair is tipped backwards a certain number of times while being loaded with a user weight which is a simulation of 5-year consumer use.

There are various large forces applied to a wheelchair during these tests and during everyday use. Forces are applied during the 2 drum test (200.000 times) and drop test (6666 times) and a one-time large force is applied during the crash test.

The major forces directions are:
1) downward/upward forces.
2) forward/backward forces.

The design of the bracket of FIG. 8 results in maintaining of the adjusted position and withstand the downward/upward forces and forward/backward forces. A high contact surface (the portions P1 of the associated surfaces SF1, SF2) is made to facilitate tightening and to keep position. A low contact area between the other parts allows sliding and avoids wedging of the profile (parts of the bracket), so that it is easy to adjust.

Furthermore, in FIG. 8 the walls of the profile have a certain dimension which were developed in the course of three crash tests, two double drum test and a drop test. The whole wheelchair needs to be as light as possible, as cheap as possible in terms of production costs and at the same time the bracket needs to be as light as possible and at the same time resist the forces and that is what the design of FIG. 8 achieves.

The earlier discussed symmetry of the design of the parts also results in lower production costs. The profiles (mounting parts) can be used on both sides of the wheelchair and as 150-1, 150-2, meaning only one type of profile needs to be extruded, which thus can be used at four places.

In conclusion, the construction and dimensioning of the bracket 150 involves a new construction and extensive and expensive testing in order to create the correct functions and to have it work as intended.

In the current embodiment this ratio is about 50%. The bracket 150 may be made of materials selected from a group consisting of: steel, aluminium, etc. The width (in the sideways direction SD) of the bracket 150 is 65 mm. The length (in the longitudinal direction LD) is 150 mm for the first mounting part 150-1 and 180 mm for the second mounting part 150-2. The thickness is 35 mm. The gap is typically a few millimetres. In the current embodiment the parts 150-1, 150-2 of the brackets 150 are designed with rotation symmetric cross-sections. The parts 150-1, 150-2 are hollow in order to save material usage. Both parts comprise a reinforcement 159 inside its hollow space. These reinforcements 159 surface to withstand the orthogonal compressive forces caused by the bolts 157 when tightened. The other walls mainly serve to provide the strength to withstand the upward/downward forces.

Whereas the embodiments discussed in the drawings are based on the second mode being a high-friction mode (when the bolts 157 are tightened), in alternative embodiments, the respective parts 150-1, 150-2, may be locked together using some sort of locking device 180. This locking device 180 may be a clamp, a lever, a knob, a pin-and-hole construction or the like.

The wheelchair of the invention with the illustrated inventive sliding bracket 150 makes it possible to change the seat height easily and quickly. All what is required is to lay the wheelchair 100 on its back (rotated 90 degrees) such that gravity is not working against a required motion during adjustment. Then the bolts 157 of each bracket 150 are loosened. Then the height can be adjusted. In embodiments having a scale printed on the bracket one may read the amount of adjustment in mm on this scale. Then at the desired height the bolts 157 are tightened and the wheelchair 100 is rotated back on its wheels. This can be done in just a few minutes. No wheel replacements or changes are necessary.

The particular embodiments disclosed above are illustrative only, as the invention may be modified and practiced in different but equivalent manners apparent to those skilled in the art having the benefit of the teachings herein. For example, variations are possible in the way parts are connected or coupled. The person skilled in the art may easily find alternative solutions for tightening, tensioning, and mounting parts. The invention covers all these variants as long as they are covered by the independent claim. No limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage. In the device claims enumerating several means, several of these means may be embodied by one and the same item of hardware.

1.-10. (canceled)

11. A wheelchair comprising a wheel frame and a seat frame connected to the wheel frame, the wheel frame being connectible to a set of front wheels and a set of rear wheels, the seat frame being configured with a seat plate for allowing a user to sit on it,
wherein the position of the wheel frame relative to the seat frame is adjustable in order to make a height of a seat of the wheelchair adjustable,
wherein the wheel frame and the seat frame are connected via at least one sliding bracket, the sliding bracket comprising a first mounting part connected to the wheel frame and a second mounting part connected to the seat frame,
wherein the first mounting part and the second mounting part are coupled together in operational use,
wherein in each sliding bracket one of the first and second mounting parts is provided with at least one elongated slot on a side facing the other one of the first and second mounting parts,
wherein each elongated slot provides access to a respective internal channel for receiving a sliding bar which can move back and forth the respective internal channel,
wherein the sliding bar is provided with at least one threaded hole for receiving a respective mounting bolt,
wherein in each sliding bracket the other one of the first and second mounting parts is provided with at least one through-hole for receiving a respective mounting bolt,
wherein the at least one through-hole is spaced apart and is aligned with the threaded holes in the sliding bar,
wherein each mounting bolt is provided through the through-hole into the respective threaded-hole such that a sliding movement of one part relative to the other part causes the respective sliding bar to slide within the respective internal channel,
wherein the sliding bracket having a first mode being a low-friction mode allowing adjustment of the height of the seat by sliding, by means of human force, the first mounting part relative to second mounting part in a stepless manner in a longitudinal direction of the bracket to obtain a desired length of the sliding bracket, the sliding bracket having a second mode being a high-friction mode resisting length adjustment between the first mounting part and the second mounting part and being capable of withstanding forces during mandatory safety, durability, and reliability tests for wheelchairs,
wherein the first mode is obtained when the mounting bolts are partially loosened, and
wherein the second mode is obtained when the mounting bolts are tightened.

12. The wheelchair according to claim 11, wherein each sliding bracket is configured with a contact interface between the first mounting part and the second mounting part having a matching topology for i) facilitating relative movement between the first and second mounting parts, when in contact, in the longitudinal direction in the first mode while blocking relative movement between the first and second mounting parts, when in contact, in a sideways direction orthogonal to the longitudinal direction, and for ii) defining the required friction in the second mode.

13. The wheelchair according to claim 12, wherein the contact interface is shaped such that, when the first mounting part and the second mounting part are pressed together in the second mode, only portions of associated surfaces can touch each other while other portions of the associated surfaces are designed to keep a gap there between.

14. The wheelchair according to claim 11, wherein each sliding bracket is configured such that the second mode is a locking mode which blocks relative movement between the first mounting part and the second mounting part.

15. The wheelchair according to claim 11, wherein the wheelchair has two respective sliding brackets arranged on opposite sides near arm rests of the wheelchair.

16. The wheelchair according to claim 11, wherein the wheelchair has four respective sliding brackets of which two arranged spaced apart at a front side of the wheelchair and two arranged spaced apart at a rear side of the wheelchair.
